(19) United States
(12) Patent Application Publication
(10) Pub. No.: US 2025/0335702 A1
(43) Pub. Date: Oct. 30, 2025

(54) DUPLICATION CHECK SYSTEM AND METHOD FOR PAPER GENERATED BY ARTIFICIAL INTELLIGENCE

(71) Applicant: Jiang Wu, Maoming (CN)

(72) Inventor: Jiang Wu, Maoming (CN)

(21) Appl. No.: 19/260,448

(22) Filed: Jul. 5, 2025

(30) Foreign Application Priority Data
Apr. 23, 2025 (CN) 202510514032.1

(51) Int. Cl. G06F 40/194; G06F 40/40

(52) U.S. Cl. CPC G06F 40/194; G06F 40/40

(57) ABSTRACT

A duplication check system and method for paper generated by artificial intelligence includes steps: S1: the user uploading the academic paper to be detected to a system, and the system automatically extracting the title, the abstract, and the headline of each paragraph of the paper; S2: fusing the title, the abstract, and the headline of each paragraph of the paper with the contextual information of the paper and extracting theme features; S3: after the different themes of the paper are extracted, repeatedly using similar tones for each theme in all different AI tools to propose integrate text requirements, searching each theme for times of the number of repetitions of integration in each AI tool until no new content is obtained, matching all the obtained texts with the paper to be duplication checked, based on natural language understanding, for duplication check, and marking the matching repeated parts and indicating the sources.

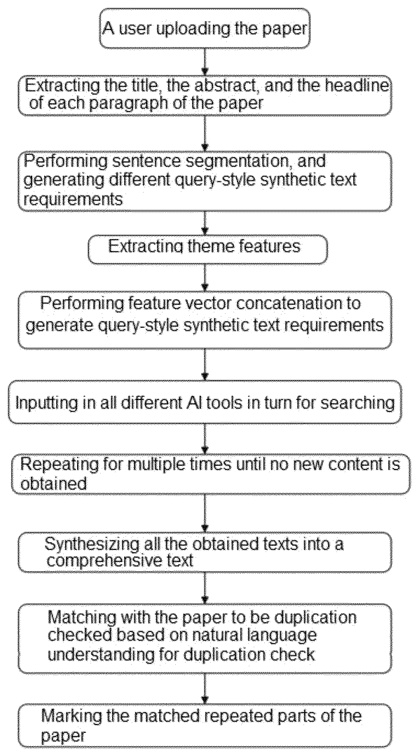

### CROSS REFERENCE TO RELATED APPLICATIONS

The present disclosure claims the priority to the Chinese patent application with the filing No. 2025105140321, entitled “DUPLICATION CHECK SYSTEM AND METHOD FOR PAPER GENERATED BY ARTIFICIAL INTELLIGENCE” and filed on Apr. 23, 2025 with the Chinese Patent Office, the contents of which are incorporated herein by reference in their entirety.

### TECHNICAL FIELD

The present disclosure belongs to the technique field of paper duplication check and detection, and particularly relates to a duplication check system and method for paper generated by artificial intelligence.

### BACKGROUND ART

With the breakthroughs in generative artificial intelligence (AI) techniques such as Chat GPT, Claude, AIPassPaper, ShortlyAI, EssayBye, Jasper.AI, ScaleNut, StoryhaAl, Peppertype-AI, Gemini, Template Lab, Scite AI, DeepSeck, Kimi, etc., AI has the ability to generate highly human-like academic texts. Traditional duplication check (plagiarism check) systems rely on “text string matching” technique, which can only detect the repetition rate with published documents, but cannot identify non-original academic misconducts generated by AI (such as logical structure imitation, semantic reorganization, cross-language translation plagiarism, etc.). According to statistics from Nature in 2023, 12% of academic submissions worldwide involve AI ghostwriting but have not been discovered by existing tools, which seriously threatens academic integrity. In response to this, the Harvard-MIT Joint Laboratory in the United States developed a semantic entropy detection model. The European Union implemented the “AI Generated Content Identification Act”. KAIST in South Korea developed neural style transfer detection technique. The technique trends are: revealing the semantic features and pattern rules of AI generated academic texts, establishing an explainable detection model, and developing a duplication check technique that can effectively identify AI generated content; developing contextual semantic similarity calculation based on Transformer; coping with the iterative upgrade of Al ghostwriting tools through dynamic adversarial training; collecting 100,000 academic texts generated by mainstream models such as Chat GPT and Claude, and extracting the statistical features of the generated texts through t-SNE visualization and perplexity analysis; establishing a quantitative model for the difference between human writing and machine writing. An algorithm that can identify traces of AI generation was developed. Stanford University proposed a “shadow model” algorithm to predict AI rewriting paths in advance. Emotional consistency detection includes: identifying emotional expression discontinuity in AI ghostwriting. NATURE and other journals jointly developed a “text fingerprint” technique to track the life cycle of paper. Tracking the latest research results at home and abroad, it is found that its technique ideas are relatively cumbersome, the project is huge, and it is difficult to implement, and it cannot fundamentally cure the plagiarism of AI generated texts.

Now CNKI, VIP network and Bigan network (www.bigan.net) in China, Turnitin in United State, etc. have launched AIGC duplication check, which identifies the characteristics of AI generated texts by analyzing the language patterns, structure and content consistency of the text, and detects fixed sentence structures and semantic coherence: AI generated texts may have identifiable sentence structure characteristics, such as simple and repeated expressions, unclear logical relationships, etc. These are accurate in identifying literary works, because AI created literary works are randomly generated based on their huge corpus. Even if the same AI tool is asked twice in less than 1 minutes using the same requirements to write a literary work with the same theme, the contents of the works obtained are different, but the characteristics of its creation are regular. For literary works, AIGC duplication check is to identify the AIGC suspicion rate obtained by identifying its creation rules. However, the identifying of academic papers is inaccurate, because the description of academic papers does not have the random literary vocabulary and sentence splicing rules like literary works, and pure AI created project proposals also cannot be detected. Moreover, the author may copy the content of the academic paper to the 66 paper platform (https://www.lunwen66.com/aigc.html), and then click the one-click AIGC suspicion rate reduction function based on DeepSeek technique. Those sentences that were misjudged by CNKI as being generated by AI have undergone earth-shaking changes under the optimization of DeepSeck powerful algorithm of the 66 paper platform. The originally mechanical and stilted expressions have become natural and smooth, and the complex sentence structure has been adjusted just right, which is completely in line with human writing habits, then the AIGC suspicion rate may drop sharply from the previous high-risk area to the safe range. Therefore, the current AIGC duplication check cannot solve the problem of duplication check in paper automatically generated by artificial intelligence. AI generated texts usually have specific characteristics, such as fluency, standardization of grammatical structure, etc. Turnitin's algorithm also makes judgments based on these characteristics, but it is not always able to accurately distinguish between human writing and AI generated content, and can only judge the AI generation suspicion rate. Turnitin's detection may also make misjudgments. For example, some high-quality AI generated texts may be mistaken for human writing, and low-quality human writing may also be mistaken for AI generation.

### SUMMARY

The purpose of the present disclosure is to provide a duplication check system and method for paper generated by artificial intelligence, so as to solve the problems raised in the above-mentioned background art.

To achieve the above purpose, the present disclosure provides the following technique solution: a duplication check method for paper automatically generated by an artificial intelligence tool, including the following steps:

S1: a user uploading to-be-detected academic paper to a system, and the system automatically extracting the title, the abstract, and the headline of each paragraph of the paper;

S2: fusing the title, the abstract, and the headline of each paragraph of the paper with the contextual information of the paper, and extracting theme features, and performing feature vector concatenation on sentences. For example, if the headline of each paragraph does not have a subject, the title of the paper may be added in front of the headline of each paragraph to generate appropriate synthetic text requirements for different AI query tools. For example, for the literary paper “Movie “Titanic” Review ”, the system may generate the first AI tool search requirement “Movie “Titanic” Review” based on the paper title, which may be transformed into a similar integrated text requirement “Please write a movie “Titanic” review” and searched multiple times in different AI tools, until no new content is obtained in each AI tool. Then, the abstract of the literary paper “Movie “Titanic” Review” is searched multiple times in different AI tools respectively until no new content is obtained in each AI tool. The first major headline in the paragraph of the literary paper “Movie “Titanic” Review” is “From the Dimension of Visual Presentation”, and because there is no subject, the system automatically extracts the subject from the title of the paper and adds “Movie “Titanic”” in front of it. Therefore, the content to be searched in AI is “Movie “Titanic” from the Dimension of Visual Presentation ”, which is then searched multiple times respectively in different AI tools until no new content is obtained in each AI tool. This is done for each major headline of the following paragraphs of the paper. For another example, the fourth subheading of the scientific paper “Research on the Innovation and Implementation of Paper Duplication check Technique in the Age of Artificial Intelligence” is “Innovative Construction of a New Generation of Multi-dimensional Academic Duplication check System”, which has no subject, and the system extracts the subject based on the title of the paper and adds “Paper Duplication check Technique in the Age of Artificial Intelligence” in front of it. Therefore, the content to be searched in AI is “Paper Duplication check Technique in the Age of Artificial Intelligence Innovative Construction of a New Generation of Multi-dimensional Academic Duplication Check System”.

S3: continuously changing a tone or generating similar requirements to generate the appropriate synthetic text requirements for the different AI query tools. For example, “Paper Duplication check Technique in the Age of Artificial Intelligence Innovative Construction of a New Generation of Multi-dimensional Academic Duplication Check System” may be transformed into “Please write a paper on paper duplication check technique in the age of artificial intelligence innovative construction of a new generation of multi-dimensional academic duplication check system”, “Method for paper duplication check technique in the age of artificial intelligence innovative construction of a new generation of multi-dimensional academic duplication check system” and other similar requirements;

S4: inputting these query or synthetic text requirements in all different AI tools (Chat GPT, Claude, AIPassPaper, ShortlyAI, EssayBye, Jasper.AI, ScaleNut, StoryhaAl, Peppertype-AI, Gemini, Template Lab, Scite AI, DeepSeck, Kimi, etc.) in turn, and changing the tone of each requirement and repeatedly searching several times, so that the different AI tools search the entire network for these substance contents of this paper and integrate according to the requirements to generate new texts, synthesizing all these AI generated texts, and then comparing with the paper to be duplication checked for duplication check;

S5: recording repeated similar sentences and marking the repeated similar sentences in the paper file; and

S6: summarizing the detected repeated sentences and their source information to generate a detection report. It is considered to be plagiarized paper or paper automatically written using the AI tool, if a certain degree of similarity is achieved.

As a further preferred embodiment of the present technical solution: S1 includes the following steps:

S11: performing word segmentation operation on sentences of the title, abstract, and headline of each paragraph of the paper, A₁={a₁, a₂, a₃, a₄, a₅}, where A₁ is a whole sentence, and a₁, a₂, a₃, a₄, a₅ are the words in the whole sentence;

As a further preferred embodiment of the present technical solution: S2 includes the following steps:

S21: searching the same requirement and similar requirements on the same AI platform for multiple times and integrating texts for generally several times until no new context is obtained substantially by further searching and integrating, because the degree of similarity of the texts obtained by different times of the searching and integrating using the same requirement and similar requirements on the same AI platform is between 15% and 80%, that is, the text obtained by one time of searching and integrating does not meet the requirements of comprehensive duplication check;

S22: continuously repeatedly searching for several times based on the same query or synthetic text requirements on all AI tool platforms because the results obtained from different AI tool platforms based on the same query or synthetic text requirements are all different, and synthesizing all texts obtained by the integrating; and

S23: extracting different appropriate query or integrated text requirements from the title, the abstract, and the headline of each paragraph of the paper which can reflect the substances of the paper, searching respectively on all AI tool platforms for multiple times, synthesizing all texts, and matching with the paper to be duplication checked based on natural language understanding, for duplication check.

As a further preferred embodiment of the present technical solution: S5 includes the following steps:

S51: performing repetition marking on the paper to set the repeated sentences to red font, or add wavy underlines to highlight them, or add a “[Duplicate]” mark at the beginning of the repeated sentence, add the corresponding annotation number at the end, and then add annotations at the end of the file centralizedly to explain the source and repetition circumstance of the repeated sentence.

Compared with the prior art, the present disclosure has the following beneficial effects.

1. In the present disclosure, by innovatively proposing a method of directly extracting the substances (title, abstract) of the paper and the key points of the headline of each paragraph, and integrating text requirements in different AI tools for duplication check, the problem of non-original academic misconducts generated by AI that traditional duplication check systems cannot identify, such as logical structure imitation, semantic reorganization, etc., is effectively solved. Secondly, natural language understanding technique is used for matching and duplication check, which can more deeply understand the semantics of the text, improve the accuracy and reliability of duplication check, and reduce misjudgments and missed judgments.

2. In the present disclosure, compared with the traditional duplication check system which is limited to the duplication check range of published documents, the method proposed in the present disclosure can also compare the paper with Internet web resources and paper generated by various AI tools, which greatly expands the duplication check range and improves the comprehensiveness and effectiveness of duplication check, thereby helping to discover and combat academic misconducts such as plagiarism performed through AI tools or network resources, and maintain academic integrity. Meanwhile, the duplication check is performed by integrating the texts generated by different AI tools, the tedious process of traditional duplication check systems that require comparing massive documents one by one is avoided, thereby improving the efficiency of duplication check.

### BRIEF DESCRIPTION OF DRAWINGS

The sole figure is a flow chart of a duplication check system and method for paper generated by artificial intelligence according to the present disclosure.

### DETAILED DESCRIPTION OF EMBODIMENTS

The technical solutions in the embodiments of the present disclosure will be clearly and completely described below in conjunction with the drawings in the embodiments of the present disclosure. Obviously, the described embodiments are only some of the embodiments of the present disclosure, not all of the embodiments. Based on the embodiments of the present disclosure, all other embodiments obtained by a person ordinarily skilled in the art without creative work are within the scope of protection of the present disclosure.

### Embodiment

As shown in the sole figure, the present disclosure provides a technique solution: a duplication check detecting method for paper automatically generated by an artificial intelligence tool, including the following steps.

S1: The user uploads the academic paper to be detected to the system, and the system automatically extracts the title, the abstract, and the headline of each paragraph of the paper.

S2: The title, the abstract, and the headline of each paragraph of the paper are fused with the contextual information of the paper, the theme features are extracted, and the sentences are subjected to feature vector concatenation. For example, if the headline of each paragraph does not have a subject, the title of the paper may be added in front of the paragraph headline for the headline of each paragraph to generate appropriate synthetic text requirements for different Al query tools. For example, if the headline of each paragraph does not have a subject, the title of the paper may be added in front of the headline of each paragraph to generate appropriate synthetic text requirements for different AI query tools. For example, for the literary paper “Movie “Titanic” Review ”, the system may generate the first AI tool search requirement “Movie “Titanic” Review” based on the paper title, which may be transformed into a similar integrated text requirement “Please write a movie “Titanic” review” and searched multiple times in different AI tools respectively, until no new content is obtained in each AI tool. Then, the abstract of the literary paper “Movie “Titanic” Review” is searched multiple times in different AI tools respectively until no new content is obtained in each AI tool. The first major headline in the paragraph of the literary paper “Movie “Titanic” Review” is “From the Dimension of Visual Presentation”, and because there is no subject, the system automatically extracts the subject from the title of the paper and adds “Movie “Titanic”” in front of it. Therefore, the content to be searched in the AI tools is “Movie “Titanic” from the Dimension of Visual Presentation”, which is then searched multiple times respectively in different AI tools until no new content is obtained in each AI tool. This is done for each major headline of the following paragraphs of the paper. For another example, the fourth subheading of the scientific paper “Research on the Innovation and Implementation of Paper Duplication check Technique in the Age of Artificial Intelligence” is “Innovative Construction of a New Generation of Multi-dimensional Academic Duplication check System”, which has no subject, and the system extracts the subject based on the title of the paper and adds “Paper Duplication check Technique in the Age of Artificial Intelligence” in front of it. Therefore, the content to be searched in the AI tools is “Paper Duplication check Technique in the Age of Artificial Intelligence Innovative Construction of a New Generation of Multi-dimensional Academic Duplication Check System”.

S3: The tone is continuously changed or similar requirements are generated, to generate the appropriate synthetic text requirements for different Al query tools. For example, “Paper Duplication check Technique in the Age of Artificial Intelligence Innovative Construction of a New Generation of Multi-dimensional Academic Duplication Check System” may be transformed into “Please write a paper on paper duplication check technique in the age of artificial intelligence innovative construction of a new generation of multi-dimensional academic duplication check system”, “Method for paper duplication check technique in the age of artificial intelligence innovative construction of a new generation of multi-dimensional academic duplication check system” and other similar requirements.

S4: These query or synthetic text requirements are inputted in all different AI tools (Chat GPT, Claude, AIPassPaper, ShortlyAI, EssayBye, Jasper.AI, ScaleNut, StoryhaAl, Peppertype-AI, Gemini, Template Lab, Scite AI, DeepSeek, Kimi, etc.) in turn, and each requirement is changed in the tone and searched repeatedly for several times, so that the different AI tools search the entire network for these substance contents of this paper and integrate according to the requirements to generate new texts. All these Al generated texts are synthesized and then compared with the paper to be duplication checked for duplication check.

S5: Repeated similar sentences are recorded and marked in the paper file.

S6: The detected repeated sentences and their source information are summarized to generate a detection report. It is considered to be plagiarized paper or paper automatically written using the AI tool, if a certain degree of similarity is achieved.

In the present embodiment, particularly: S1 includes the following steps.

S11: Word segmentation operation is performed on sentences of the title, the abstract, and the headline of each paragraph of the paper, A₁={a₁, a₂, a₃, a₄, a₅}, where A₁ is a whole sentence, and a₁, a₂, a₃, a₄, a₅ are the words in the whole sentence;

In the present embodiment, particularly: S2 includes the following steps:

S21: because the degree of similarity of the texts obtained by different times of the searching and integrating using the same requirement and similar requirements on the same AI platform is between 15% and 80%, that is, the text obtained by one time of searching and integrating does not meet the requirements of comprehensive duplication check, the same requirement and similar requirements may be searched on the same platform for multiple times and the texts are integrated for generally several times until no new context is obtained substantially by further searching and integrating.

S22: The results obtained from different AI tool platforms based on the same query or synthetic text requirements are all different, so the searching based on the same query or synthetic text requirements are repeated continuously for several times on all AI tool platforms respectively, and all texts obtained by the integrating are synthesized.

S23: Different appropriate query or integrated text requirements are extracted from the title, the abstract, and the headline of each paragraph of the paper which can reflect the substance of the paper, and searched respectively on all AI tool platforms for multiple times. All the texts obtained are synthesized and matched with the paper to be duplication checked for duplication check based on natural language understanding.

In the present embodiment, particularly: S5 includes the following steps.

S51: Repetition marking is performed on the paper to set the repeated sentences to red font, or add wavy underlines to highlight them, or add a “[Duplicate]” mark at the beginning of the repeated sentence, add the corresponding annotation number at the end, and then add annotations at the end of the file centralizedly to explain the source and repetition circumstance of the repeated sentence.

In the above, the duplication check method is a simple, practical, and minimally resource-intensive comprehensive paper duplication check method. There is no need to study the semantic features and pattern rules of AI-generated academic texts to identify whether AI writing is used, and there is no need to additionally search all web resources to determine whether the paper plagiarizes online resources. It directly extracts the substance (title, abstract) of the paper to be duplication checked, the key points of each paragraph headline, and proposes the integrated text requirements in different AI tools with appropriate requirements. The AI tool can then capture the relevant web pages to generate text according to the requirements, and the software then synthesizes all the text combinations, and then matches the synthesized result with the paper to be duplication checked for duplication check. If the paper quotes the part created by AI, it is required to be marked, otherwise the paper may be considered to fail the duplication check, if the comprehensive duplication check repetition rate exceeds a certain proportion. In addition, the system may also use natural language understanding technique, which is not a simple word matching, and it is not possible to avoid being identified by the duplication check by changing the order of sentences and the order of the words. Instead, it is considered as plagiarism if the semantics are understood to be the same.

Although embodiments of the present disclosure have been shown and described, it will be appreciated by those ordinarily skilled in the art that various changes, modifications, substitutions and variations may be made to the embodiments without departing from the principles and spirit of the present disclosure, and that the scope of the present disclosure is defined by the appended claims and their equivalents.

1. A duplication check method for paper generated by artificial intelligence (AI), comprising following steps:
S1: a user uploading an academic paper to be duplication checked to a system, and the system automatically extracting a title, an abstract, and a headline of each paragraph of the paper;
S2: fusing the title, the abstract, and the headline of each paragraph of the paper with contextual information of the paper, extracting theme features, and performing feature vector concatenation on sentences, wherein for the headline of the each paragraph having no subject, the title of the paper is added in front of the headline of the each paragraph, to generate appropriate synthetic text requirements for different AI query tools;
S3: continuously changing a tone or generating similar requirements to generate the appropriate synthetic text requirements for the different AI query tools;
S4: inputting the synthetic text requirements in all different AI tools—Chat GPT, Claude, AI Pass Paper, Shortly AI, Essay Bye, Jasper. AI, Scale Nut, HuggingChat, copy.AI, Google Bard, Hyperwriteai, Al paperPass, ChatSonic, Parapraphgenerator.org, StoryhaAl, Peppertype-AI, Volcano Writing, Gemini, Template Lab, Scite AI, deep Seek, and Kimi—in turn, and changing the tone of each of the requirements and repeatedly searching for several times, so that the different AI tools search entire network for substance contents of the paper and integrate according to the requirements to generate new texts, synthesizing all AI generated texts, and then comparing with the paper to be duplication checked for duplication check;
S5: recording repeated similar sentences, and marking the repeated similar sentences in a paper file; and
S6: summarizing detected repeated sentences and source information thereof, to generate a detection report, wherein it is considered to be plagiarized paper or paper automatically written using an AI tool if a degree of similarity is achieved.

2. The duplication check method for paper generated by artificial intelligence according to claim 1, wherein the S1 comprises following step:
S11: performing word segmentation operation on sentences of the title, the abstract, and the headline of each paragraph of the paper, A₁={a₁, a₂, a₃, a₄, a₅}, wherein A₁ is a whole sentence, and a₁, a₂, a₃, a₄, a₅ are words in the whole sentence.

3. The duplication check method for paper generated by artificial intelligence according to claim 2, wherein the S2 comprises following steps:
S21: searching a same requirement and similar requirements on the same AI platform for multiple times and integrating texts for generally several times until no new context is obtained substantially by further searching and integrating, because a degree of similarity of the texts obtained by different times of the searching and integrating using the same requirement and similar requirements on the same AI platform is between 15% and 80% and thus a text obtained by one time of searching and integrating does not meet requirements of comprehensive duplication check;
S22: searching for several times based on a same query or synthetic text requirement on all AI tool platforms respectively, because results obtained from the different AI tool platforms based on the same query or synthetic text requirement are all different, and synthesizing all texts obtained by integrating; and
S23: extracting different appropriate query or integrated text requirements from the title, the abstract, and the headline of each paragraph of the paper which can reflect the substances of the paper, searching respectively on all AI tool platforms for multiple times, synthesizing all texts, and matching with the paper to be duplication checked based on natural language understanding, for duplication check.

4. The duplication check method for paper generated by artificial intelligence according to claim 3, wherein the S5 comprises following step:
S51: performing repetition marking on the paper to set repeated sentences to red font or add wavy underlines for highlighting.
